(19) United States
(12) Patent Application Publication
(10) Pub. No.: US 2010/0169379 A1
(43) Pub. Date: Jul. 1, 2010

(54) SYSTEM AND METHOD FOR CREATING USER-SPECIFIC DIRECTORY

(76) Inventors: Patrick Joseph O'Sullivan, Ballsbridge (IE); Edith Helen Stern, Yorktown Heights, NY (US); Robert Cameron Weir, Westford, MA (US); Barry E. Willner, Briarcliff Manor, NY (US)

Correspondence Address: HOLLAND & KNIGHT, 10 ST. JAMES AVENUE, BOSTON, MA, 02116-3889, US

(21) Appl. No.: 12/345,094

(22) Filed: Dec. 29, 2008

(51) Int. Cl. G06F 17/30

(52) U.S. Cl. 707/791; 707/E17.044

(57) ABSTRACT

A system and method for accessing a master directory including a master set of contact users, the master directory defining an organizational structure. A contact directory is defined for a user based upon, at least in part, the organizational structure defined within the master directory. The contact directory includes a subset of the contact users.

### TECHNICAL FIELD

This disclosure relates to contact directories and, more particularly, to systems and methods for creating user-specific contact directories.

### BACKGROUND

Oftentimes individuals in an organization require contact and personnel information from peers across the organization. Such information may pertain to employee contact information, employee location or department, employee manager information, and so on. Such information may be found in a corporate directory, e.g., which may include contact information and corporate organization structure. Typically, a corporate directory may be accessed from a browser, rich client, PDA client, cellular phone, and similar devices/application.

Situations may arise in which an individual is disconnected from the network (e.g. working off-line, on the road, in a meeting room with no network connectivity, on a train), but may require information on a peer, for example to make contact with a peer. In conventional systems, in which a corporate directory is accessible via a network such as the internet, the individual may be unable to look up the peers contact information. To overcome this problem, the individual may have the ability to replicate the entire corporate directory locally for accessing off-line.

In large organizations, replicating an entire directory locally may not be feasible or desirable. For example, when using memory constrained devices (such as PDA's or cellular phones), the device may not have the memory resources to store a multi-thousand employee corporate directory. Issues associated with the size of the directory are sometimes resolved by eliminating some of the content to reduce the off-line footprint. For example, the off-line directory may only include user name and contact number, removing photo/images, organizational position, and such. However, removing some of this content may challenge or dilute specifics of a query that an off-line user may have.

Even if the off-line footprint is not limited, an individual may not need or desire the entire corporate directory. For example, the individual may only regularly interact with a relatively small number of peers. It may be considered cumbersome and undesirable to have to search through an entire corporate directory for the desired information every time contact information is needed.

### SUMMARY OF THE DISCLOSURE

In a first implementation, a computer program product resided on a computer readable medium having a plurality of instructions stored one it. When executed by a processor, the instructions cause the processor to perform operations including accessing a master directory including a master set of contact users. The master directory defines an organizational structure. A contact directory for a user is defined based upon, at least in part, the organizational structure defined within the master directory. The contact directory includes a subset of the contact users.

One or more of the following features may be included. The instructions for defining the contact directory may include instructions for defining the contact directory based upon, at least in part, an organizational hierarchy defined within the master directory. The instructions for defining the contact directory may include instructions for defining the contact directory based upon, at least in part, an organizational distance of the contact users relative to the user. The instructions for defining the contact directory may include instructions for defining the contact directory based upon, at least in part, one or more organizational units defined within the master directory. The instructions for defining the contact directory may include instructions for populating one or more contact directory fields based upon, at least in part, information from the master directory. The instructions for defining the contact directory for the user may include instructions for populating one or more contact directory fields based upon, at least in part, one or more user defined preferences.

Instructions may be included for modifying the contact directory for the user based upon, at least in part, a change in a master directory. Instructions may also be included for notifying the user of the change in the master directory. Instructions may be included for making the contact directory for the user available offline.

In another implementation, a computing system includes a processor and a memory module couple with the processor. A first software module is executable by the processor and the memory module. The first software module is configured to access a master directory including a master set of contact users, the master directory defining an organizational structure. A second software module is also executable by the processor and the memory module. The second software module is configured to define a contact directory for a user based upon, at least in part, the organizational structure defined within the master directory, the contact directory including a subset of the contact users.

One or more of the following features may be included. The second software module, which may be configured to define the contact directory, may be configured to define the contact directory based upon, at least in part, an organizational hierarchy defined within the master directory. The second software module, which may be configured to define the contact directory, may be configured to define the contact directory based upon, at least in part, one or more organizational units defined within the master directory. The second software module, which may be configured to define the contact directory for the user, may be configured to populate one or more contact directory fields based upon, at least in part, one or more user defined preferences.

A third software module may be executable by the processor and the memory module. The third software module may be configured to modify the contact directory for the user based upon, at least in part, a change in a master directory. A fourth software module may be executable by the processor and the memory module. The fourth software module may be configured to make the contact directory for the user available offline.

In yet another implementation, a method includes accessing a master directory including a master set of contact users. The master directory defines an organizational structure. A contact directory for a user is defined based upon, at least in part, the organizational structure defined within the master directory. The contact directory includes a subset of the contact users.

One or more of the following features may be included. Defining the contact directory may include defining the contact directory based upon, at least in part, an organizational hierarchy defined within the master directory. Defining the contact directory may include defining the contact directory based upon, at least in part, an organizational distance of the contact users relative to the user. Defining the contact directory may include defining the contact directory based upon, at least in part, one or more organizational units defined within the master directory. Defining the contact directory may include populating one or more contact directory fields based upon, at least in part, information from the master directory. Defining the contact directory for the user may include populating one or more contact directory fields based upon, at least in part, one or more user defined preferences.

The contact directory for the user may be modified based upon, at least in part, a change in the master directory. The user may be notified of the change in the master directory. The contact directory for the user may be made available offline.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts a directory creation process and a relationship application coupled to a distributed computing network.

FIG. 2 is a flowchart of a process executed by the directory creation process of FIG. 1.

FIG. 3 is a diagrammatic view of an organizational structure defined by the master directory.

FIG. 4 is a diagrammatic view of a user-specific contact directory created by directory creation process.

FIG. 5 is a diagrammatic view of a user-specific contact directory created by directory creation process.

### DETAILED DESCRIPTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

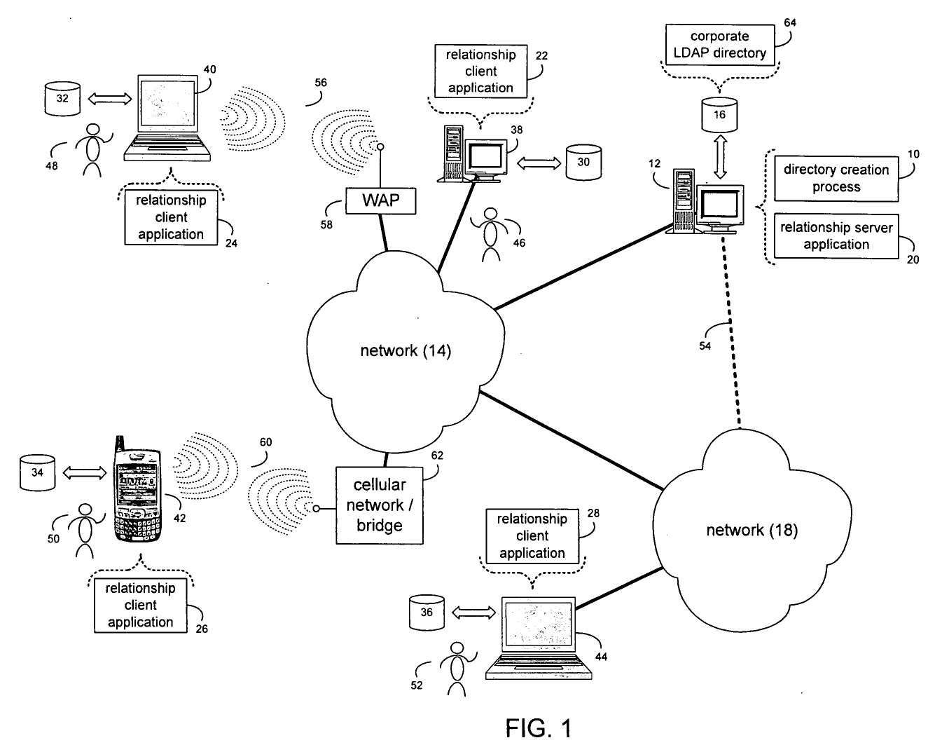

Referring to FIG. 1, there is shown directory creation process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Alternatively, directory creation process may reside on a client electronic device, such as a personal computer, notebook computer, personal digital assistant, or the like.

As will be discussed below in greater detail, directory creation process 10 may allow a user to create a contact directory that may include user-specific contacts, i.e., may include one or more contact users that may have particular relevance to the user. A master directory, including a master set of contact users, may be accessed. The master directory may define an organizational structure. The contact directory for a user may be defined based upon, at least in part, the organizational structure defined within the master directory. The contact directory includes a subset of the contact users. The user-specific contact directory may include, for example, contact information for one or more other users, including, but not limited to, email addresses, instant messaging user identification, telephone numbers, mailing addresses, company and position information, biographical information, and the like.

The instruction sets and subroutines of directory creation process 10, which may include one or more software modules, and which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more relationship server applications (e.g., relationship server application 20), examples of which may include but are not limited to email server applications that may include calendar and/or scheduling modules or components (e.g., Lotus Domino™ Server and Microsoft Exchange™ Server), instant messaging server applications (e.g., IBM Lotus Sametime™, Microsoft Office Live Communications Server™, Jabber XCP™, and AOL Instant Messenger™), voice over IP server applications or PBX telephone systems. Relationship server application 20 may interact with relationship client applications 22, 24, 26, 28, examples of which may include, but are not limited to, email client applications that may include calendar and/or scheduling modules (e.g., Lotus Notes™ and Microsoft Outlook™), instant messaging client applications (e.g., AOL Instant Messenger™, IBM Lotus Sametime™, Google Talk™), voice over IP client applications, and softphone applications. Directory creation process 10 may be a stand alone application that interfaces with relationship server application 20 or may be an applet/application that is executed within relationship server application 20.

The instruction sets and subroutines of relationship server application 20, which may be stored on storage device 16 coupled to server computer 12, may be executed by one or more processors (not shown) and one or more memory architectures (not shown) incorporated into server computer 12.

As mentioned above, in addition/as an alternative to being a server-based application residing on server computer 12, the directory creation process may be a client-side application (not shown) residing on one or more client electronic device 38, 40, 42, 44 (e.g., stored on storage device 30, 32, 34, 36, respectively). As such, the directory creation process may be a stand alone application that interfaces with a relationship client application (e.g., relationship client applications 22, 24, 26, 28), or may be an applet/application that is executed within a relationship client application. As such, the directory creation process may be a client-side process, a server-based application, or a hybrid client-side/server-based process, which may be executed, in whole or in part, by server computer 12, or one or more of client electronic device 38, 40, 42, 44.

The instruction sets and subroutines of relationship client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and a memory stick storage devices. Examples of client electronic devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using relationship client applications 22, 24, 26, 28, users 46, 48, 50, 52 may engage in relationship activities (e.g., send/receive email communications, conduct instant messaging chats, schedule calendar events, conduct telephone conversations, and similar activities). Engaging in relationship activities may include accessing relationship server application 20.

Users 46, 48, 50, 52 may access relationship server application 20 directly through the device on which the relationship client application (e.g., relationship client applications 22, 24, 26, 28) is executed, namely client electronic devices 38, 40, 42, 44, for example. Users 46, 48, 50, 52 may access relationship server application 20 directly through network 14 or through secondary network 18. Further, server computer 12 (i.e., the computer that executes relationship server application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

### Directory Creation Process

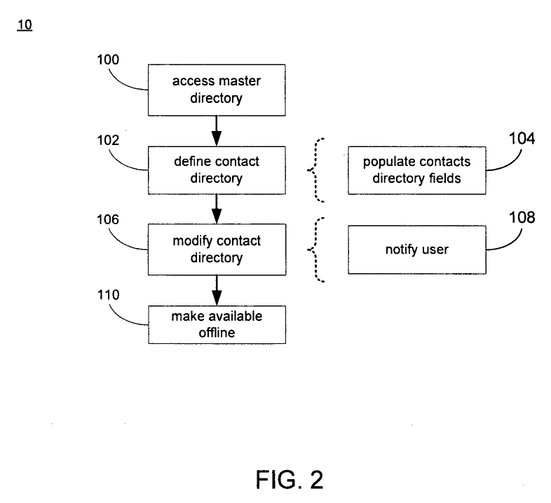

Referring also to FIG. 2, directory creation process 10 may access 100 a master directory including a master set of contact users. The master directory may define an organizational structure. Directory creation process 10 may further define 102 a contact directory for a user based upon, at least in part, the organizational structure defined within the master directory. The contact directory may include a subset of the contact users.

Directory creation process 10 may access 100 the master directory (e.g., LDAP directory 64, residing on storage device 16 coupled to server computer 12, which may be a corporate LDAP directory). LDAP directory 64 may include a listing of individuals (e.g., including user 46, user 48, user 50, user 52) associated with the organization (e.g., individuals that work for the company). Further, LDAP directory 64 may include a hierarchical structure of the organization. The hierarchical structure may be either explicitly defined (e.g., based upon, for example, an organizational structure tree or the like), or implicitly defined (e.g., based upon, at least in part, entries for individuals included within LDAP directory 64 may include associated rank/title information, department and group information, and like) within LDAP directory 64.

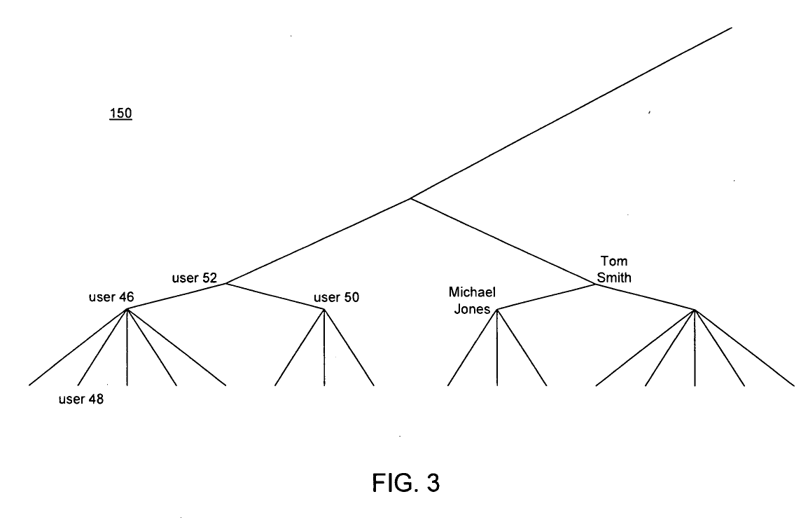

For example, and referring also to FIG. 3, users 46, 48, 50, 52 may be members of an organization (e.g., a corporation) having hierarchal structure 150. As discussed above, hierarchal structure 150 may be, for example, implicitly or explicitly defined in a corporate LDAP (Lightweight Directory Access Protocol) directory (e.g., LDAP directory 64), or similar directory. LDAP directory 64 may reside on storage device 16 couple to server computer 12. User 46 may have a higher relative hierarchal status relative to user 48 and an equal hierarchal status relative to user 50. User 52 may have a higher hierarchal status relative to users 46, 48, 50.

Based upon, at least in part, hierarchal structure 150 defined within LDAP directory 64, user 46 and user 50 may be peers, being located within the same department, and may be of equivalent rank/title. Additionally, user 46 may be a superior of user 48, e.g., based upon, at least in part, user 46 having a higher hierarchal status than user 48, and upon user 46 and user 48 being in the same department. User 52 may be a superior of user 46, user 48, and user 50, e.g., by virtue of user 52 having a higher hierarchal status than user 46, user 48, and user 50, and by virtue of user 46, user 48, user 50, and user 52 being in the same department.

Defining 102 the contact directory may include defining the contact directory based upon, at least in part, an organizational distance of the contact users relative to the user. Assume for the purpose of illustration that statistically users may most frequently interact with others users who are within one level of hierarchal separation. Based upon, for example, the statistical interaction pattern, system profile settings or the like, may be established such that directory creation process 10 may define 102 a contact directory for user 46 based upon, at least in part, an organizational distance of plus or minus one relative to user 46. As such, the contact directory defined for user 46 may include user 48, user 50, user 52, Tom Smith, and Michael Jones, who may have an organizational distance of one from user 46.

Further, defining 102 the contact directory may include defining the contact directory based upon, at least in part, one or more organizational units defined within the master directory. For example, an organization, such as a company, may include various divisions, e.g., which may be made up of various departments and teams, and the like. Similar to defining 102 the contact directory based upon, at least in part, organizational distance, assume for illustrative purposes that statistically users may most frequently interact with those users in their division and/department (as well as any sub-divisions thereof).

Continuing with the above-stated example, directory creation process 10 may define 102 a contact directory for user 46 including those users within the same division or department as user 46. Defining 102 the contact directory for user 46 based upon, at least in part, organizational units defined within LDAP directory 64 may provide an independent basis for defining the contact directory and/or may be used in conjunction with one or more additional basis for defining 102 the contact directory. For example, defining 102 the contact directory may include defining 102 the contact directory based upon both an organization distance and based upon organizational units. According to an exemplary embodiment, directory creation process 10 may define a contact directory for user 46 including users having an organization distance of one from user 46, and residing within the same department as user 46. Accordingly, directory creation process 10 may define 102 a contact directory for user 46 (e.g., which may be a user specific contact directory) that may include a subset of the users included within LDAP directory 64.

While the foregoing description has related to defining 102 a contact directory based upon organization distance and/or organizational units based upon statistical frequency of interaction, this is intended for illustrative purposes only, and should not be construed as a limitation of this disclosure. Various additional and/or alternative bases for selecting organizational distance and/or organization units for defining 102 the contact directory may be equally utilized, depending upon design criteria and/or user preference.

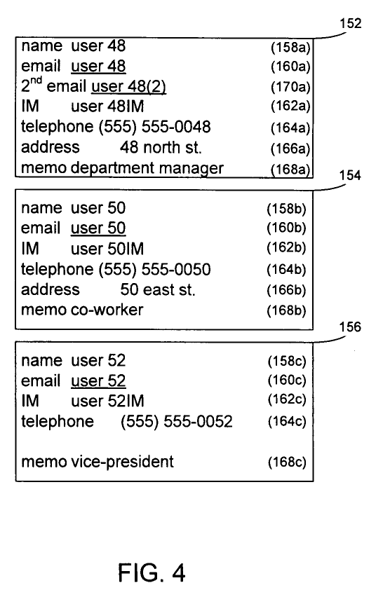

Defining 102 the contact directory may include populating 104 one or more contact directory fields based upon, at least in part, information from the master directory. For example, and referring also to FIG. 4, a user-specific contact directory for user 46 is shown. The user-specific contact directory may include one or more directory entries (e.g., entries 152, 154, 156). Each directory entry 152, 154, 156 may define one or more information field, including but not limited to, “name” field 158-c, “email ” field 160a-c, “IM” field 162a-c, “telephone” field 164a-c, “address” field 166a-b, and “memo” field 168a-c. As discussed above, directory creation process 10 may access 100 a master directory (e.g., LDAP directory 64), and directory creation process 10 may populate 104 one or more field (e.g., “name” field 158-c, “email ” field 160a-c, “IM” field 162a-c, “telephone” field 164a-c, “address” field 166a-b, and “memo” field 168a-c of directory entries 152, 154, 156).

Continuing with the above stated example, directory entry 152 may be associated with user 48. Directory creation process 10 may populate 104 “name” field 158a with the name of user 48 (i.e., user 48). Directory creation process 10 may similarly populate 104 “email” field 160a with the email address of user 48 (i.e., user 48), based upon an email address for user 48 included within LDAP directory 64. Further, directory creation process 10 may populate 104 “IM” field 162a, “telephone” field 164a, “address” field 166a, and “memo” field 168a with information included within LDAP directory 64. Directory creation process 10 may similarly populate 104 directory entry 154, directory entry 156 corresponding to user 50, user 52 respectively, in a corresponding manner.

Directory creation process 10 may populate 104 one or more field of the user-specific contact directory based upon, at least in part, one or more user defined preferences. Continuing with the above-stated example, in FIG. 4 directory entries 152, 154, 156 may include “name” field 158-c, “email” field 160a-c, “IM” field 162a-c, “telephone” field 164a-c, “address” field 166a-b, and “memo” field 168a-c. User 46 may add and/or remove fields from one or more of the directory entries (e.g., directory entry 152, 154, 156). For example, directory creation process 10 may allow user 46 to add “2^{nd} email” field 170 to directory entry 152. As such, user 46 may include second email address associated with user 48 (i.e., user 48(2)). Similarly, directory creation process 10 may allow user 46 to delete the address field from directory entry 156. As such, user 46 may be allowed to customize individual entries, deciding what fields are included with the various entries. User 46 may also be allowed to make blanket changes that applied to all of the directory entries.

Directory creation process 10 may modify 106 the user-specific contact directory based upon, at least in part, a change in the master directory (e.g., LDAP directory 64). For example, one or more of the attributes (e.g., email address, instant messaging ID, telephone number, and such) associated with a user (having an associated entry in the user-specific contact directory) may change over time (e.g. due to transfers, change in job, moving). A master directory (e.g., LDAP directory 64) may be updated to reflect the changes in the attributes associated with the user. Directory creation process 10 may modify 106 the user-specific directory to also reflect the changes in the attributes associated with the user.

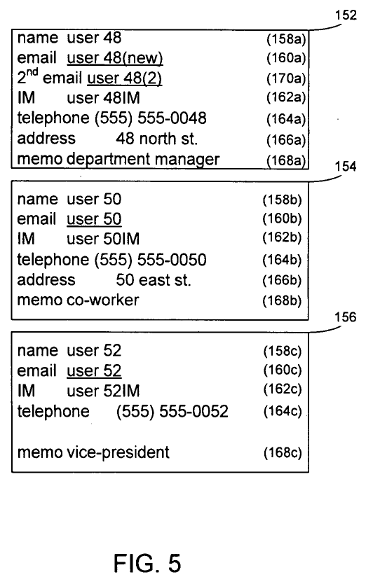

Continuing with the above stated example, one or more of the fields (e.g., field 158a, 160a, 162a, 164a, 166a, 168a, 170a) of directory entry 152 associated with user 48 in the user-specific contact directory may have been populated 104 based upon information from the master directory. For example, at the time directory entry 152 was created user 48 may have had an email address user 48, as reflected in “email” field 160a in FIG. 4. At some time after directory entry 152 was initially created, user 48's email address may change (e.g., to user 48(new)). The change in user 48's email address may be reflected in, for example, LDAP directory 64. Referring also to FIG. 5, directory creation process 10 may modify 106 “email” field 160a of directory entry 152 associated with user 48 to correspond to the change in user 48's email address, which is reflected in the master directory.

Similarly, directory creation process 10 may modify 106 one or more field of a directory entry to reflect other changes, e.g., personnel changes. For example, user 52 may be user 46's manager at the time directory entry 158 was initially created. Subsequently, user 52 may be replaced with a new manager. Based upon, at least in part, the change in organization structure, e.g., reflected in LDAP directory 64, directory creation process 10 may create a directory entry for user 46's new manager, and may populate one or more field of the directory entry with associated information. Various other modification of user-specific contact directory may also be made by directory creation process 10 based upon, at least in part, changes in a general directory.

Directory creation process 10 may compare directory entries 152, 154, 156 in the user-specific contact directory to the master directory based upon, at least in part, various policies. For example, directory creation process 10 may compare the user-specific contact directory to one or more master directory on a predetermined schedule (e.g., once a day, once a week, once a month). Additionally/alternatively, directory creation process 10 may compare the user-specific contact directory to the master directory whenever directory creation process 10 is executed. Various other policies may be implemented for comparing the user-specific contact directory to the master directory.

Directory creation process 10 may notify 108 the user of a change in the master directory. For example, directory creation process 10 may notify 108 the user of a change in the master directory in comparison to the user-specific contact directory in addition/as an alternative to modifying 106 the user-specific contact directory. For example, in the event of a change in the master directory compared to the user-specific contact directory, directory creation process 10 may notify 108 the user of the change and prompt the user to accept or reject modification of the user-specific contact directory to correspond with the general directory.

Directory creation process 10 may notify 108 the user of the change, e.g., via a popup, email, instant messaging notice, etc. Directory creation process 10 may notify 108 the user of the change as soon as the change is recognized by directory creation process 10. Similarly, directory creation process may notify 108 the user of the change the first time the user-specific directory is accessed once the change is recognized by directory creation process 10. Additionally/alternatively, directory creation process 10 may notify 108 the user of the change the first time the user attempts to access the changed directory entry after the change is recognized by directory creation process 10.

Directory creation process 10 may make 110 the user-specific contact directory available offline. For example, directory creation process 10 may allow a user to download the user-specific contact directory to a client electronic device (e.g., client electronic devices 38, 40, 42, 44). As such, the user-specific contact directory may be accessible by the user via the client electronic device, for example, even when the client electronic device is not connected to a network (e.g., networks 14, 18).

The user-specific contact directory created by directory creation process 10 may provide a user with a more valuable contact directory, e.g., as compared to a general contact directory, such as a corporate directory. For example, while the user may have access to a complete corporate directory (e.g., including the complete information of all of the employees of the corporation) the user may typically only interact with a relatively small portion of the employees of the corporation. It may be cumbersome to have to sort through an entire corporate directory (e.g., to find an email address or phone number of a desired contact) every time the user wants to interact with an individual. Additionally, user-specific contact directory may be relatively small, as compared to an entire corporate directory that may be relatively large. The smaller size of the user-specific contact directory may be more manageable, e.g., for use with memory constrained device, such as a PDA, cellular phone, etc.

In addition to providing the convenience of size and accessibility of contacts that are most relevant to the user, the user-specific contact directory may also provide the convenience of being an organic construct that may evolve as the individuals that a user interacts with changes. For example, the directory creation process 10 may add new people to the user-specific directory that the user begins interacting with, removes those that the user has not interacted with for a long time.

A number of implementations have been described. Nevertheless, it will be understood that various modifications may be made. Accordingly, other implementations are within the scope of the following claims.

What is claimed is:

1. A computer program product residing on a computer readable medium having a plurality of instructions stored thereon which, when executed by a processor, cause the processor to perform operations comprising:
accessing a master directory including a master set of contact users, the master directory defining an organizational structure; and
defining a contact directory for a user based upon, at least in part, the organizational structure defined within the master directory, the contact directory including a subset of the contact users.

2. The computer program product of claim 1, wherein the instructions for defining the contact directory include instructions for defining the contact directory based upon, at least in part, an organizational hierarchy defined within the master directory.

3. The computer program product of claim 1, wherein the instructions for defining the contact directory include instructions for defining the contact directory based upon, at least in part, one or more organizational units defined within the master directory.

4. The computer program product of claim 1, wherein the instructions for defining the contact directory for the user include instructions for populating one or more contact directory fields based upon, at least in part, one or more user defined preferences.

5. The computer program product of claim 1, further including instructions for modifying the contact directory for the user based upon, at least in part, a change in a master directory.

6. The computer program product of claim 1, further including instructions for making the contact directory for the user available offline.

7. A computing system comprising:
a processor;
a memory module couple with the processor;
a first software module executable by the processor and the memory module, wherein the first software module is configured to access a master directory including a master set of contact users, the master directory defining an organizational structure; and
a second software module executable by the processor and the memory module, wherein the second software module is configured to define a contact directory for a user based upon, at least in part, the organizational structure defined within the master directory, the contact directory including a subset of the contact users.

8. The computing system of claim 7, wherein the second software module, configured to define the contact directory, is configured to define the contact directory based upon, at least in part, an organizational hierarchy defined within the master directory.

9. The computing system of claim 7, wherein the second software module, configured to define the contact directory, is configured to define the contact directory based upon, at least in part, one or more organizational units defined within the master directory.

10. The computing system of claim 7, wherein the second software module, configured to define the contact directory for the user, is configured to populate one or more contact directory fields based upon, at least in part, one or more user defined preferences.

11. The computing system of claim 7, further including a third software module executable by the processor and the memory module, wherein the third software module is configured to modify the contact directory for the user based upon, at least in part, a change in a master directory.

12. The computing system of claim 7, further including a fourth software module executable by the processor and the memory module, wherein the fourth software module is configured to make the contact directory for the user available offline.

13. A method comprising:
accessing a master directory including a master set of contact users, the master directory defining an organizational structure; and
defining a contact directory for a user based upon, at least in part, the organizational structure defined within the master directory, the contact directory including a subset of the contact users.

14. The method of claim 13, wherein defining the contact directory includes defining the contact directory based upon, at least in part, an organizational hierarchy defined within the master directory.

15. The method of claim 13, wherein defining the contact directory includes defining the contact directory based upon, at least in part, one or more organizational units defined within the master directory.

16. The method of claim 13, wherein defining the contact directory includes populating one or more contact directory fields based upon, at least in part, information from the master directory.

17. The method of claim 13, further including modifying the contact directory for the user based upon, at least in part, a change in the master directory.

18. The method of claim 13, further including making the contact directory for the user available offline.
